(19) United States
(12) Patent Application Publication
(10) Pub. No.: US 2002/0101726 A1
(43) Pub. Date: Aug. 1, 2002

(54) TELECOMMUNICATIONS EQUIPMENT TRANSPORTATION APPARATUS

(76) Inventor: TIMOTHY J. DENMEADE, LOWER BURRELL, PA (US)

Correspondence Address: GERALD J IWANEJIKO JR., COHEN & GRIGSBY PC, 11 STANWIX STREET 15TH FLOOR, PITTSBURGH, PA, 15222

(21) Appl. No.: 09/473,759

(22) Filed: Dec. 28, 1999

(51) Int. Cl. H02B 1/01

(52) U.S. Cl. 361/831

(57) ABSTRACT

The telecommunications equipment transportation apparatus of the present invention is comprised of components including a base section, a container section and a harness system. The base provides a suspension which forms the supporting foundation for the unit and the equipment stored therein, and houses a power circuit that includes electrical outlet(s) for providing battery or generator-supplied alternating current (AC) or direct current (DC) power to the transported telecommunications equipment. The container is comprised of compartments that can be totally sealed for transport and storage, along with panel(s) which open to allow access to the viewing monitor and controls of transported equipment such as computers and TV sets. The container preferably provides a mounting point for the base and incorporates flexible ventilated structural panels along one or more or all surfaces and includes an internal strapping arrangement to provide an adjustable locking mechanism to secure and contain the transported equipment. The harness system is designed for multiple application use to accommodate placement of the transported equipment in different locations and configurations, and includes fasteners and straps designed to secure the system both from the interior and exterior, along with multiple attachment points to allow for adjustment of either the external harness system and/or internal harness system to accommodate differently sized and/or constructed anchoring points for the unit. An optional carrying strap is designed so the system can be transported as a hand held unit, and fasteners and straps can be arranged so that the unit can be hung from any mounting point. The unit optionally includes a modular storage case which is used for storage of accessories and personal items, which can be opened and hinged down or removed entirely from the unit in order to allow carrying or positioning in a different location.

### FIELD OF THE INVENTION

The present invention relates to an apparatus for remotely transporting telecommunications equipment for portable use, and in particular to an apparatus for transportation of such equipment for use away from the home or office.

### BACKGROUND OF THE INVENTION

Telecommunications transportation equipment existing in the state of the art suffers from several problems with regard to ease and portability of use as well as protection of the transported equipment. Deficiencies in equipment size, modularity, materials, water resistant integrity, internal and external structural support, remote power supply capability, user and equipment access, storage capacity, and design compatibility with the transportation medium and/or platform contribute to these problems, all of which are addressed and overcome by the present invention.

The present invention provides a unique carrying and fastening system designed for remotely transporting telecommunications equipment for portable use and in particular provides an apparatus for transportation of such devices, including but not limited to computer equipment, telephones, televisions (TVs) and television video cassette recorder (VCR) units, for use away from the home or office, both separately and in combination with each other and with other peripheral and accessory equipment. The telecommunications equipment transportation apparatus of the present invention is designed to protect, organize, fasten and allow access to such equipment during transportation and use. The invention incorporates high quality construction into a well thought out design in terms of size, modularity, materials, water resistant integrity, internal and external structural support, remote power supply capability, user and equipment access, storage capacity, and design compatibility with the transportation medium and/or platform configuration to overcome the problems posed by the prior art. The invention enables people to safely bring along fragile telecommunications equipment for use in a variety of remote settings. The invention can be configured for use in vehicles such as but not limited to boats, minivans, sport utility vehicles, campers and cars, and in remote locations and buildings, as well as providing a convenient and professional means to transport such equipment for use in business presentation settings.

Accordingly, it is an object of the present invention to provide a unique carrying and fastening system designed for remotely transporting telecommunications equipment for portable use.

It is another object of the present invention to provide an apparatus for transportation of telecommunications equipment for use away from the home or office.

It is another object of the present invention to provide an apparatus for transporting devices such as but not limited to computer equipment, telephones, televisions and television video cassette recorder units, for use both separately and in combination with each other and with other peripheral and accessory equipment.

It is another object of the present invention to provide a telecommunications equipment transportation apparatus designed to protect, organize, fasten and allow access to such equipment during transportation and use.

It is another object of the present invention to provide a telecommunications equipment transportation apparatus for that incorporates a unique and improved construction and design in terms of size, modularity, materials, water resistant integrity, internal and external structural support, remote power supply capability, user and equipment access, storage capacity, and design compatibility with the transportation medium and/or platform configuration to overcome the problems posed by the prior art.

It is another object of the present invention to provide a telecommunications equipment transportation apparatus that enables people to safely bring along fragile telecommunications equipment for use in a variety of remote settings.

It is another object of the present invention to provide a telecommunications equipment transportation apparatus that can be configured for use in vehicles such as but not limited to boats, minivans, sport utility vehicles, campers and cars, and in remote locations and buildings as well as providing a convenient and professional means to transport such equipment for use in business presentation settings.

### SUMMARY OF THE INVENTION

The present invention relates to an apparatus for remotely transporting telecommunications equipment for portable use, and in particular to an apparatus for transportation of such equipment for use away from the home or office. The telecommunications equipment transportation apparatus of the present invention is comprised of components including a base section, a container section and a harness system. The base provides a suspension which forms the supporting foundation for the unit and the equipment stored therein, and houses a power circuit that includes electrical outlet(s) for providing battery or generator-supplied alternating current (AC) or direct current (DC) power to the transported telecommunications equipment.

The container can be comprised of compartments that can be totally sealed for transport and storage, along with panel(s) which open to allow access to the viewing monitor and/or controls of transported equipment such as computers and TV sets. The container preferably provides a mounting point for the base and incorporates flexible ventilated structural panels along one or more or all surfaces, and also includes an internal strapping arrangement to provide an adjustable locking mechanism to secure and contain the transported equipment

The harness system is designed for multiple application use to accommodate placement of the transported equipment in different locations and configurations, and includes fasteners and straps designed to secure the system both from the interior and exterior, with multiple attachment points to allow for adjustment of either the external harness system and/or internal harness system to accommodate differently sized and/or constructed anchoring points for the unit. An optional carrying strap is designed so the system can be transported as a hand held unit, and the fasteners and straps can be arranged so that the unit can be hung from any mounting point.

The unit optionally includes a modular storage case which is used for storage of accessories and personal items, and which can be opened and hinged down or removed entirely from the unit in order to allow carrying or positioning in a different location.

The subject matter which is regarded as the invention is particularly pointed out and distinctly claimed in the concluding portion of the specification. The invention, however, together with further objects and advantages thereof, may best be understood by reference to the following description taken in conjunction with the accompanying drawings

### BRIEF DESCRIPTION OF THE DETAILED DRAWINGS

FIG. 1 provides a perspective view of the telecommunications equipment transportation apparatus of the present invention.

FIGS. 2 and 3 respectively provide a perspective view and elevation view of the base section of the telecommunications equipment transportation apparatus of the present invention.

FIG. 4 provides an overhead view of the base section displaying the electrical circuitry of the telecommunications equipment transportation apparatus of the present invention.

FIGS. 5 and 6 provide a perspective view of the container section of the telecommunications equipment transportation apparatus of the present invention.

FIGS. 7 through 10 provide a perspective view of the harness system of the telecommunications equipment transportation apparatus of the present invention.

FIGS. 11a through 11c provide various perspective views of the modular storage compartment used in connection with the telecommunications equipment transportation apparatus of the present invention.

### DETAILED DESCRIPTION OF THE PREFERRED EMBODIMENT

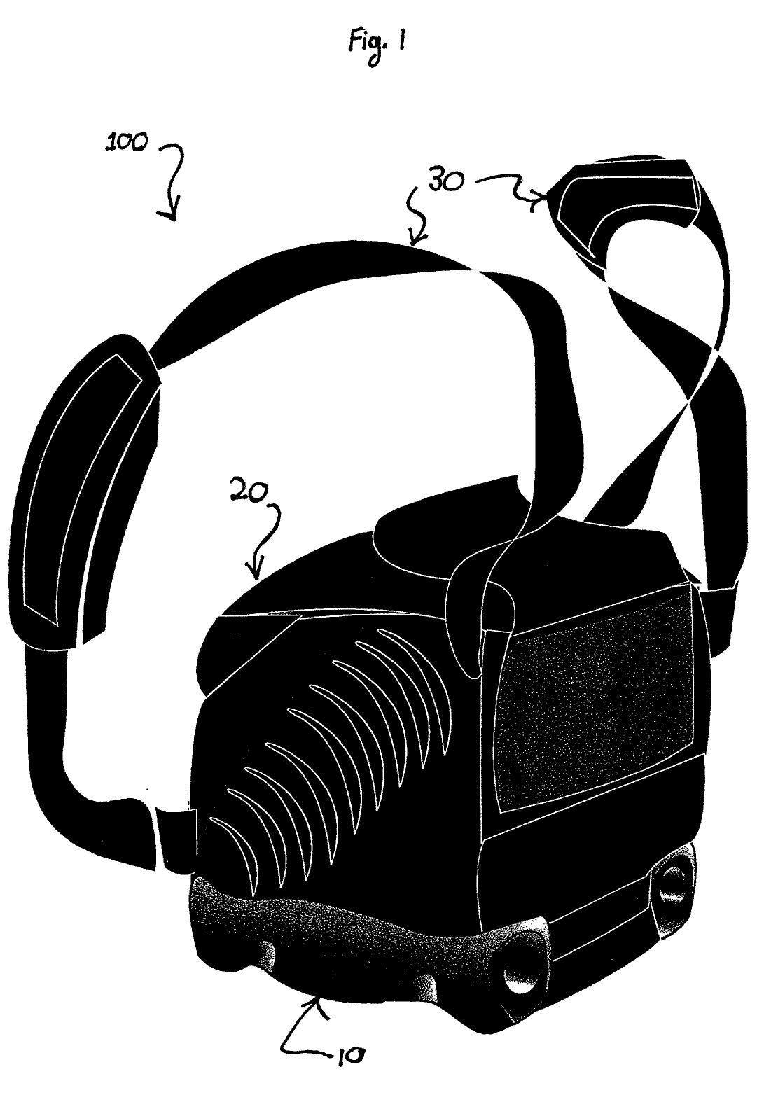

The telecommunications equipment transportation apparatus 100 of the present invention, shown generally in FIG. 1, consists of the following major components: base section 10; container section 20; and harness system 30, plus an optional modular storage compartment 40 (not shown in FIG. 1).

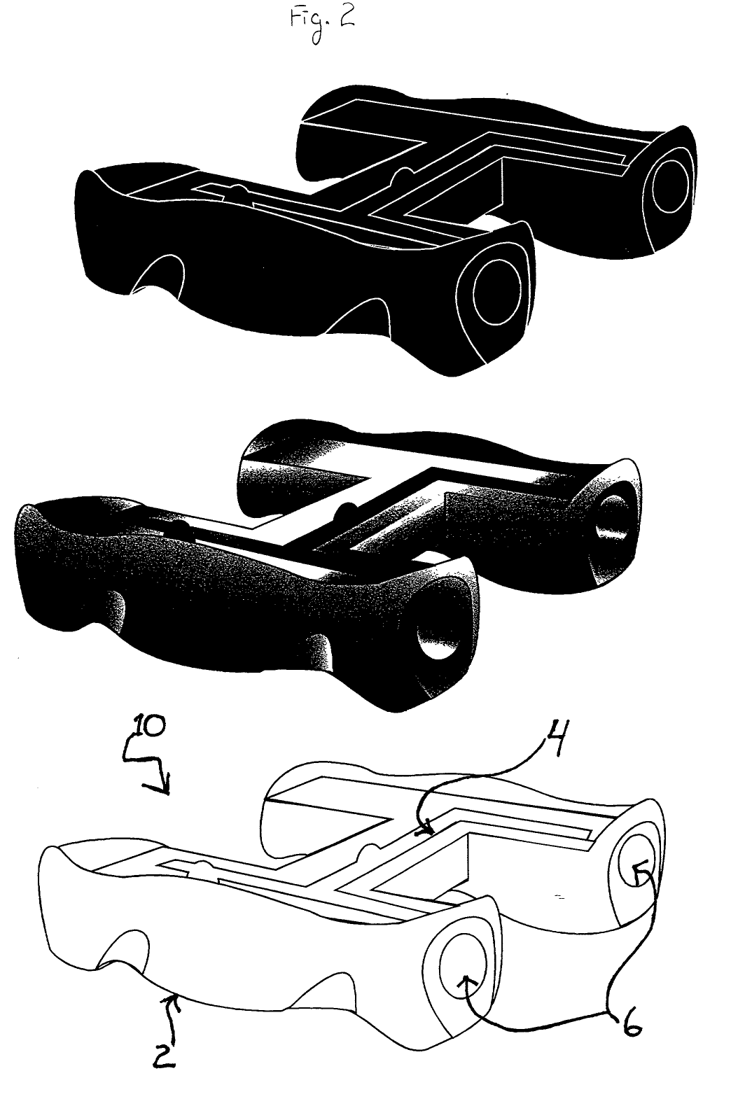

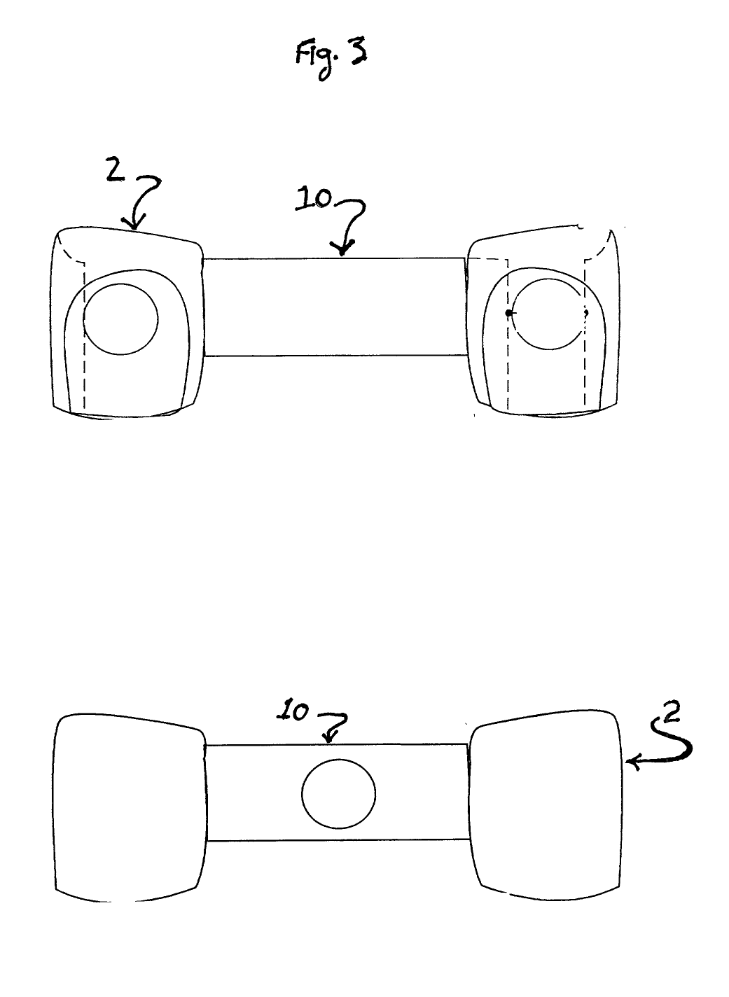

As shown in FIGS. 2 and 3, base 10 is preferably made of a lightweight molded water resistant construction which protects the system from the elements and also provides a sturdy suspension which forms the supporting foundation for the unit 100 and the equipment stored therein. The molded base 10 is preferably constructed of plastic or rubber based materials to provide a friction fit for securing the stored equipment when acting in cooperation with the harness system 30. FIGS. 2 and 3 show a preferred configuration of base 10 including legs 2 that are capable of being configured with extensions that accommodate varying viewing angles for the equipment when in use. Base 10 can optionally be configured with molded rubber mounts placed at various locations (not shown) along its structure to enhance the friction fit of the device when in use.

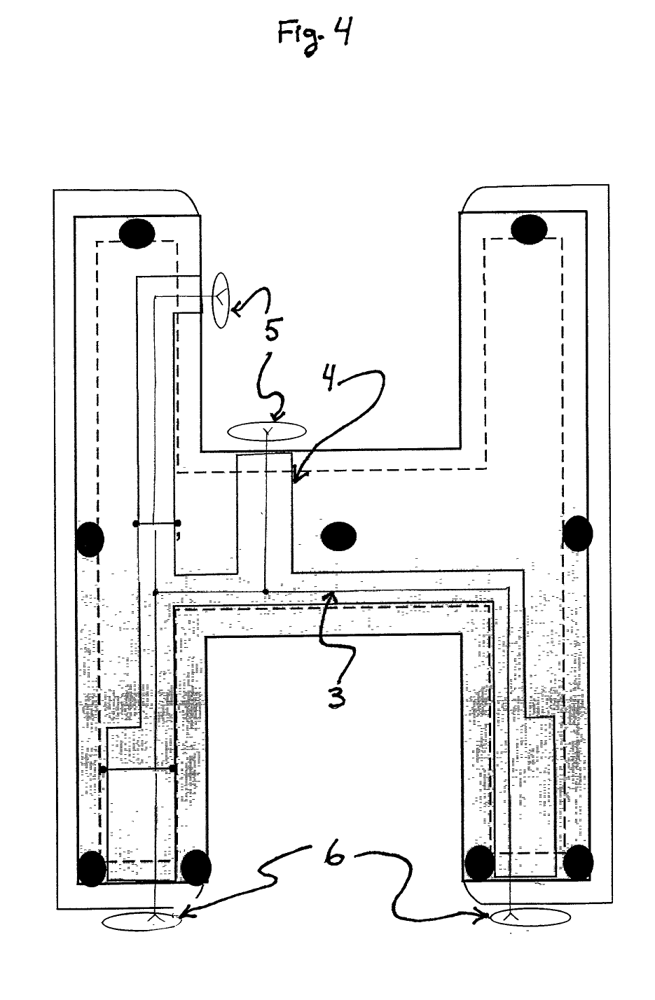

As shown in FIG. 4, base 10 houses a power circuit 3 within a channel 4 molded into the base 10. Power circuit 3 includes electrical outlet(s) 5 and 6 for providing battery or generator-supplied alternating current (AC) or direct current (DC) power to the transported telecommunications equipment, which can include but is not limited to computer equipment, telephones, televisions (TVs) and television video cassette recorder (VCR) units, used both separately and in combination with each other and with other peripheral and accessory equipment. Outlets 5 and 6 can also accommodate the use of peripheral electronic equipment such as CD players, printers, fax machines, video and audio cassette equipment, video games, AC/DC converters, modems, radios, etc. Power circuit 3 exits the base at outlets 5 and 6 and is configured to provide sufficient power cord length to accommodate the supply of external DC or AC power to the unit 100.

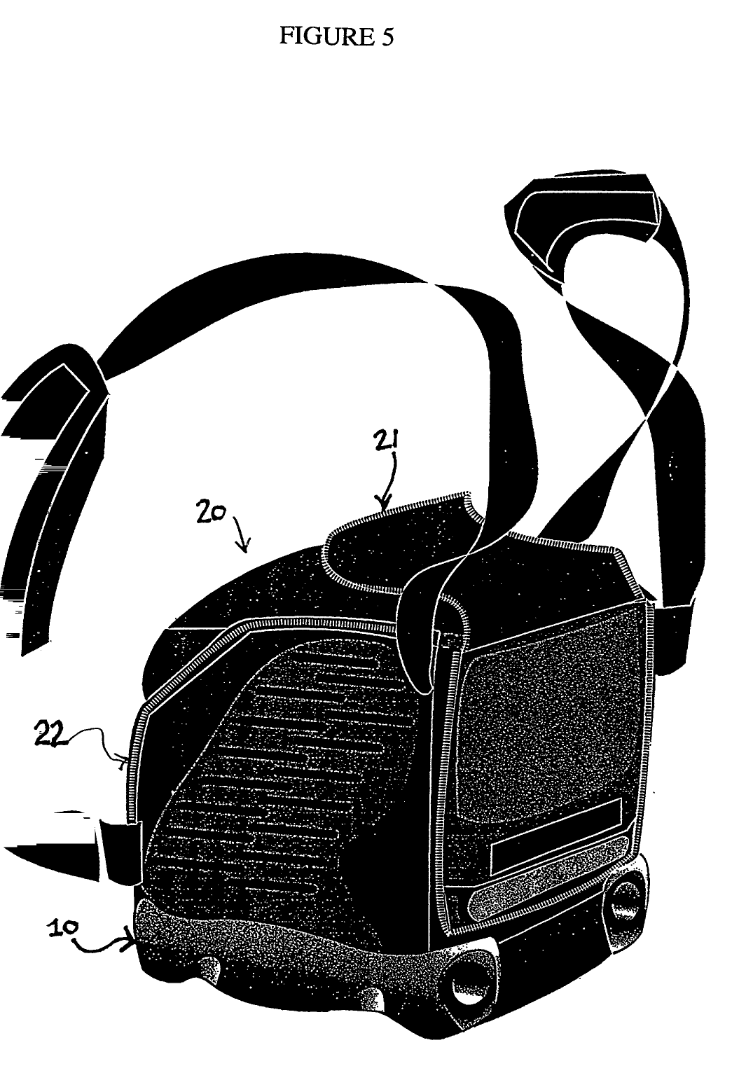

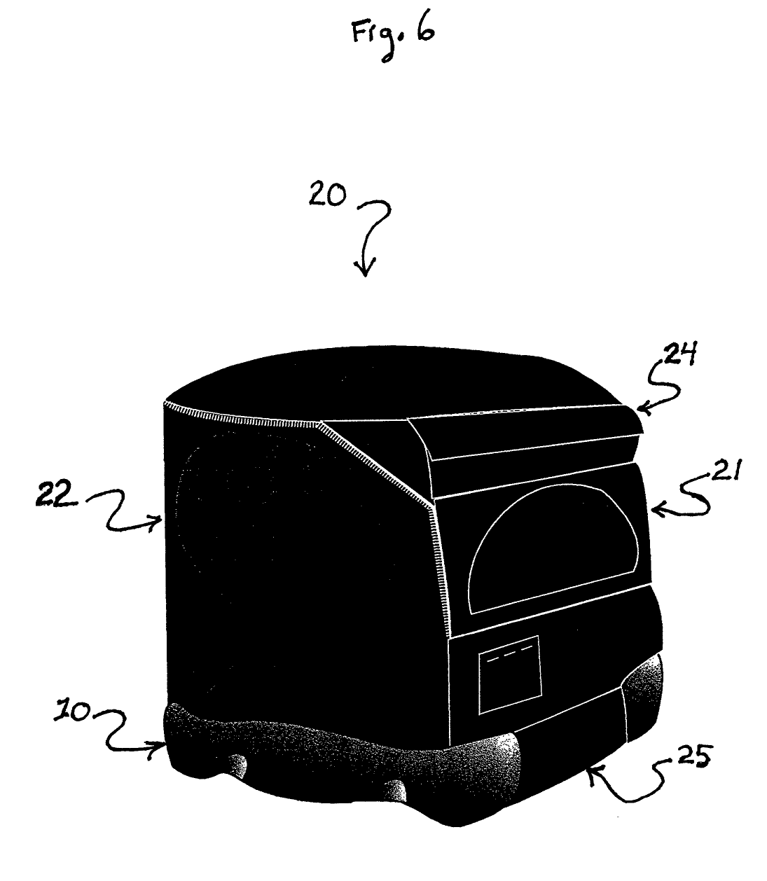

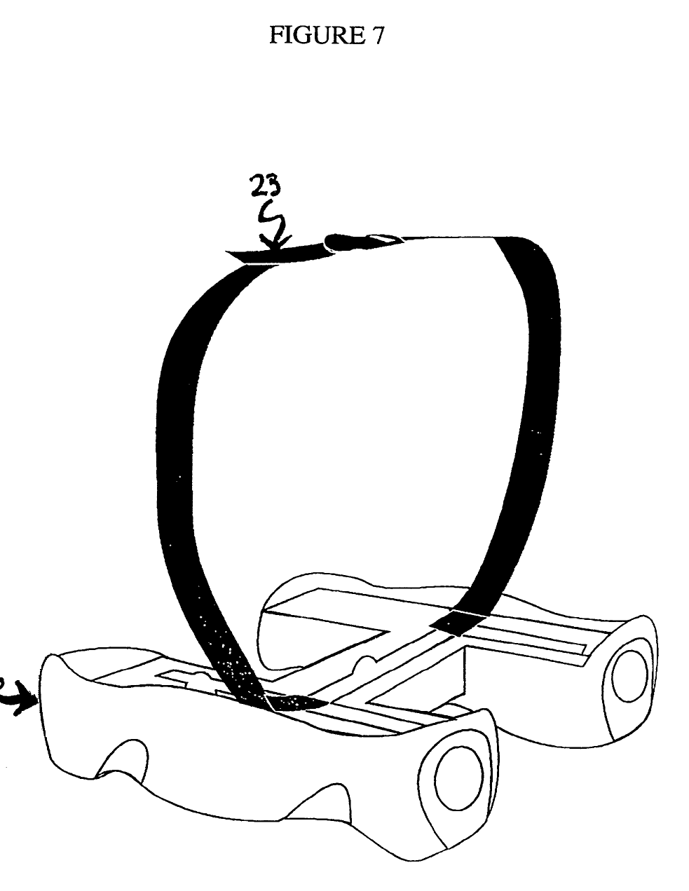

Container 20 is shown in FIGS. 5 and 6 and is preferably constructed of light weight, durable materials similar to those used in the manufacture of luggage, duffel bags and backpacks. The exterior and/or interior contact surfaces of container 20 preferably incorporate a padded or otherwise reinforced construction to protect vulnerable electronic equipment from handling wear and tear. The compartments of container section 20 can be totally sealed for transport and storage, but can optionally include panel(s) 21 which open to allow access to the viewing monitor and/or controls of the transported equipment such as computers and TV sets. Container section 20 incorporates flexible ventilated structural panels 22 along one or more or all surfaces to maintain the shape of the container 20 and provide a mounting point for the base 10 and harness system 30. As shown in FIG. 7, container 20 uses an internal strapping arrangement 23 that preferably uses rubber coated straps to provide an adjustable but solid locking mechanism to secure and contain the transported equipment. Container 20 also optionally includes zippered or Velcro or other similarly fastenable openings 24 located where required on any portion of the device to accommodate various interface components such as antennas, remote control devices, headsets, cables, mouses, modem and other connection jacks, adapters, etc., and can include independent storage compartments 25 to contain the AC and DC power connection equipment.

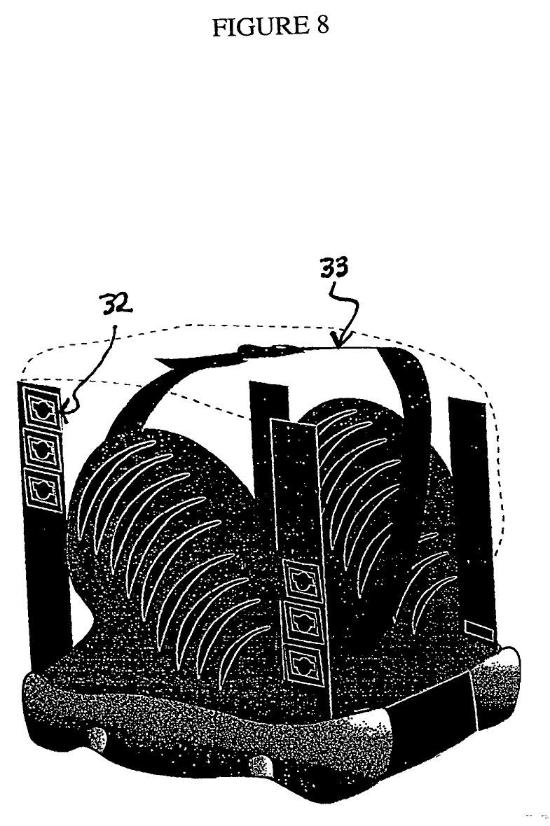

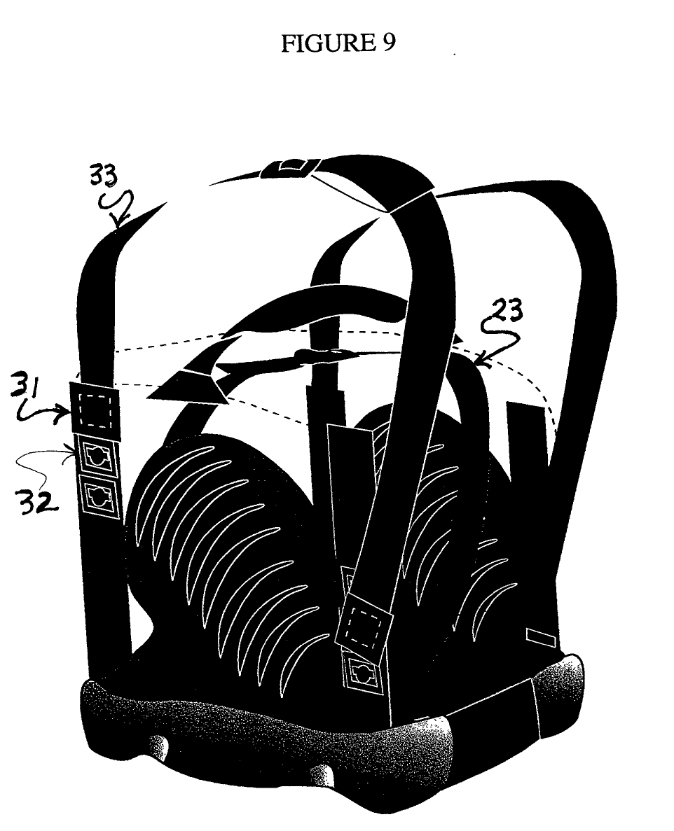

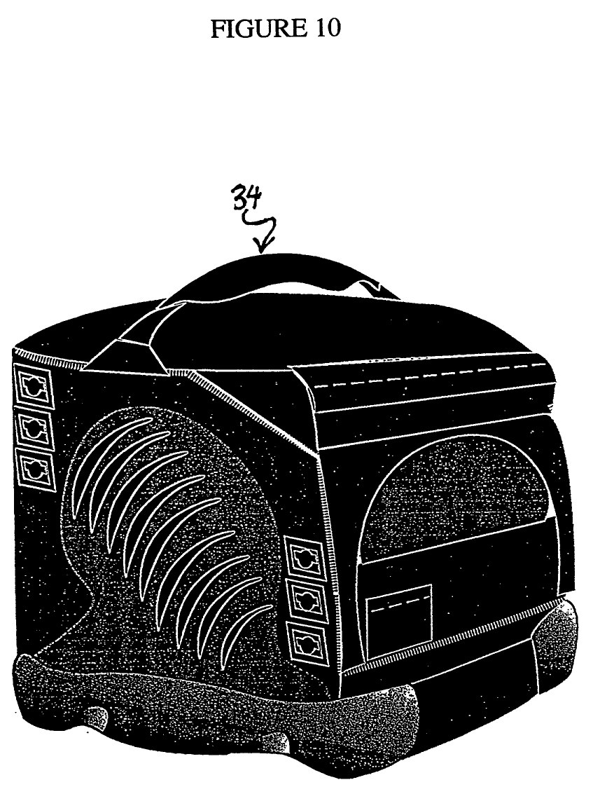

As shown in FIGS. 7-10, a unique aspect of the present invention is its multi-application harness system 30 which accommodates safe and convenient placement and securement of the transported equipment in a variety of locations and configurations. Preferably, fasteners 31 and 32 and straps 23 and 33 are designed to provide maximum flexibility for secure arrangement of the system in most vehicles, including boats, vans, sport utility vehicles (SUVs) and cars, using existing attachment points such as seats and head rests. As shown in FIGS. 8 and 9, fasteners 31 and 32 provide multiple attachment points to allow for adjustment of either external harness system 30 and/or internal harness system 23 to accommodate differently sized and constructed seats positioned in different planes. As shown in FIG. 10, an optional carrying strap 34 is designed so the system 100 can be easily transported as a hand held unit. Likewise, fasteners 31 and 32 and straps 23 and 33 can be arranged so that the unit 100 can be simply hung from a mounting point on a vertical surface.

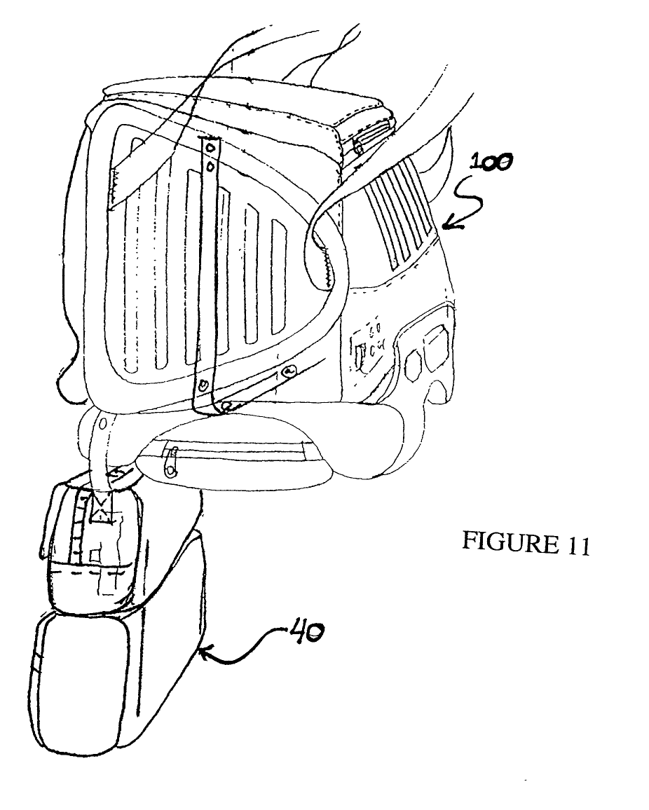

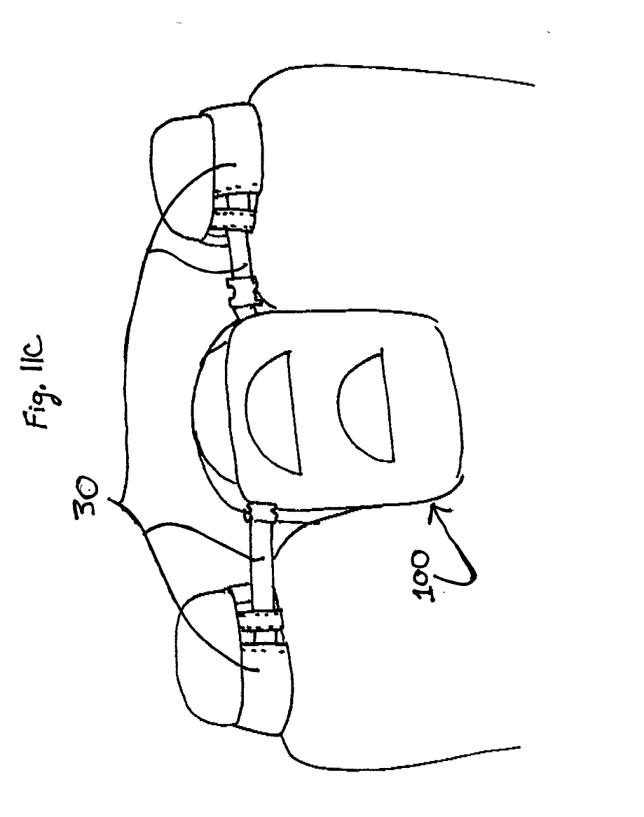

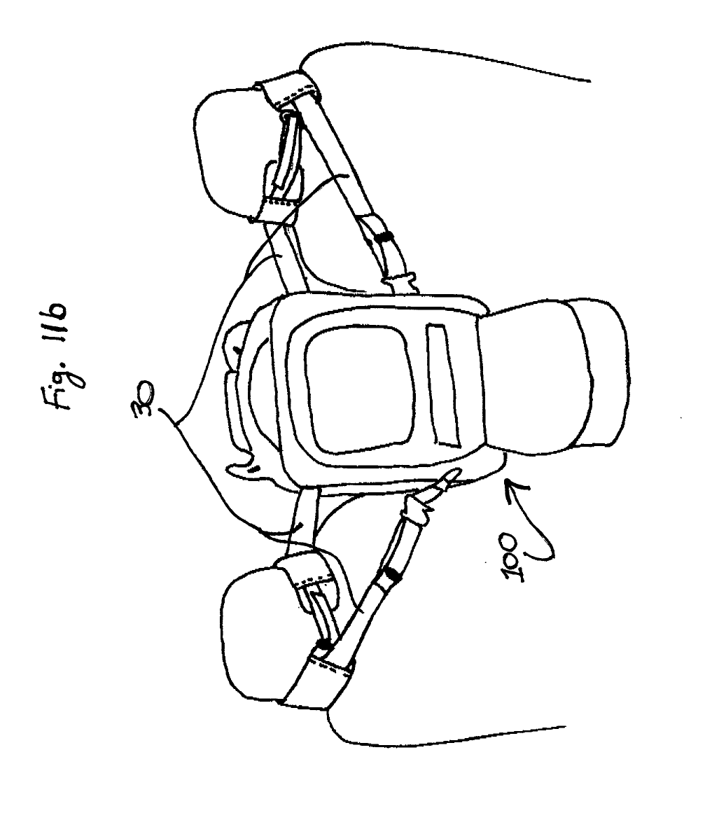

As shown in FIG. 1 la, the telecommunications equipment transportation unit 100 can optionally include a modular storage case 40 which is perfect for organizing and protecting accessories such as compact disks, tapes, games, audio and videocassettes, etc., and for providing a convenient place to carry personal items. As shown in FIG. 11a, modular storage case 40 can be opened and hinged down or removed entirely from the unit 100 in order to allow carrying or positioning in a different location. FIGS. 11b and 11c show a rear and front view, respectively, of the unit 100 as installed between the seats of a vehicle.

While only certain preferred features of the invention have been shown by way of illustration, many modifications and changes can be made. It is to be understood that the appended claims are intended to cover all such modifications and changes as fall within the true spirit and scope of the invention, as embodied in the following claims.

What is claimed is:

1. A telecommunications equipment transportation apparatus, comprising:
(a) a base section for supporting said equipment so that it may be transported to different locations in a portable mode;
(b) a container section attached to said base section for storing said equipment within said apparatus during transportation; and
(c) a harness system in communication with said base and said container section for securing said equipment during transportation.

2. The telecommunications equipment transportation apparatus of claim 1, wherein said base further comprises
(a). a suspension which forms the supporting foundation for said apparatus and said equipment stored therein; and
(b). a power circuit comprising outlet(s) for providing electrical power to said equipment.

3. The telecommunications equipment transportation apparatus of claim 2, wherein said outlets supply electrical power selected from the group consisting of alternating current or direct current.

4. The telecommunications equipment transportation apparatus of claim 1, wherein said container is comprised of:
(a) at least one flexible compartment that can be reversibly sealed for transport and storage of said equipment; and
(b) at least one flexible panel which opens to allow access to said equipment for use.

5. The telecommunications equipment transportation apparatus of claim 4, wherein said compartments are ventilated along one or more or surfaces.

6. The telecommunications equipment transportation apparatus of claim 1, wherein said compartment includes an internal strapping arrangement providing an adjustable mechanism to secure and contain said equipment.

7. The telecommunications equipment transportation apparatus of claim 6, wherein said internal strapping arrangement includes a locking mechanism.

8. The telecommunications equipment transportation apparatus of claim 1, wherein said harness system includes fasteners and straps for securing said equipment from the interior and/or exterior of said apparatus.

9. The telecommunications equipment transportation apparatus of claim 8, wherein said fasteners and straps include multiple attachment points to allow for adjustment from said interior and/or exterior of said apparatus to accommodate differently sized and/or constructed and/or located mounting points for said apparatus.

10. The telecommunications equipment transportation apparatus of claim 1, wherein said harness system includes a carrying strap for transport of said apparatus as a hand held unit.

11. The telecommunications equipment transportation apparatus of claim 1, wherein said apparatus further comprises a modular storage case configured for hinged opening and/or removal from said apparatus in order to allow carrying or positioning of said storage case in a location different from said apparatus.

12. The telecommunications equipment transportation apparatus of claim 1, wherein said apparatus stores equipment selected from the group consisting of computer equipment, telephones, televisions, compact disk players, printers, fax machines, video and audio cassette equipment, games, AC/DC converters, radios, antennas, remote control devices, headsets, cables, mouses, modems, connection jacks and adapters.
